(19) United States
(12) Patent Application Publication
(10) Pub. No.: US 2003/0031499 A1
(43) Pub. Date: Feb. 13, 2003

(54) Quenched foam applicators for polymerizable adhesives, and methods of making and using the same

(75) Inventors: William L. Heard, Raleigh, NC (US); Lawrence H. Mainwaring, Raleigh, NC (US)

Correspondence Address: OLIFF & BERRIDGE, PLC, P.O. BOX 19928, ALEXANDRIA, VA, 22320, US

(73) Assignee: CLOSURE MEDICAL CORPORATION, Raleigh, NC (US)

(21) Appl. No.: 09/897,080

(22) Filed: Jul. 3, 2001

(51) Int. Cl. B43K 5/14

(52) U.S. Cl. 401/133; 401/132

(57) ABSTRACT

An applicator for dispensing adhesive material includes a quenched foam material, provided so that the adhesive material comes in contact with the quenched foam material. Thus, polymerization of the adhesive material is initiated in the absence of additional polymerization initiators. In addition, the applicator is configured to permit improved control and economy in application of the adhesive.

### BACKGROUND OF THE INVENTION

1. Field of Invention

The present invention relates to devices and methods for applying, and preferably concurrently initiating polymerization of, polymerizable or cross-linkable materials using a foam material. The present invention in particular relates to applicators including a quenched foam, and methods of applying polymerizable or cross-linkable materials using such an applicator.

2. Description of Related Art

Monomer and polymer adhesives are used in both industrial (including household) and medical applications. Included among these adhesives are the 1,1-disubstituted ethylene monomers and polymers, such as the α-cyanoacrylates. Since the discovery of the adhesive properties of such monomers and polymers, they have found wide use due to the speed with which they cure, the strength of the resulting bond formed, and their relative ease of use. These characteristics have made the α-cyanoacrylate adhesives the primary choice for numerous applications such as bonding plastics, rubbers, glass, metals, wood, and, more recently, biological tissues.

It is known that monomeric forms of α-cyanoacrylates are extremely reactive, polymerizing rapidly in the presence of even minute amounts of an initiator, including moisture present in the air or on moist surfaces such as animal (including human) tissue. Monomers of α-cyanoacrylates are anionically polymerizable or free radical polymerizable, or polymerizable by zwitterions or ion pairs to form polymers. Once polymerization has been initiated, the cure rate can be very rapid.

Medical applications of adhesive compositions include use as an alternate or an adjunct to surgical sutures and staples in wound closure as well as for covering and protecting surface wounds such as lacerations, abrasions, burns, ulcers such as stomatitis, sores, and other open surface wounds. When such an adhesive is applied, it is usually applied in its monomeric form, and the resultant polymerization gives rise to the desired adhesive bond.

However, with the application of adhesive in a monomeric form, due to the rapid polymerization rate of the monomers, it has been challenging to design effective and commercially viable packaging and dispensing systems. Such packaging and dispensing systems must counterbalance the competing requirements that the monomer not prematurely polymerize, that the monomer be easily applied and that the monomer polymerizes at a desired rate upon application.

Various dispensing and packaging systems for adhesives have been proposed. These systems include large bottles with a single applicator, such as a large single- or multi-use brush; small applicators such as small ampoules containing monomer that can be expelled through an integral or replaceable applicator; and the like.

An often critical design element in such applicators and application methods is that a polymerization initiator or rate modifier is often needed to start or accelerate the polymerization reaction of the monomeric adhesive. Fast initiation or cure time is needed in many applications to help ensure that a proper bond is formed, and to ensure that the adhesive composition remains at the desired site of application. However, incorporation of a polymerization initiator or rate modifier in the applicator or application method can lead to more complex devices and methods, as well as to increased cost and complexity of product design and manufacture.

For example, an effective applicator system is disclosed in U.S. Pat. No. 5,928,611 to Leung. This patent discloses an applicator system generally comprising a tube containing a frangible vial of monomeric adhesive composition. One end of the tube is sealed, and the other end is closed by an applicator tip comprising a solid support having a polymerization or cross-linking accelerator or initiator for the monomeric adhesive disposed thereon or therein. As shown in FIG. 3 of the patent, the applicator tip can be generally dome-shaped. The applicator device of U.S. Pat. No. 5,928,611 is shown as FIG. 1 herein, although the applicator tip portion 500 of the depicted applicator 100 is made of the material of the present invention. An applicator device 100 comprises a cylindrical applicator container 200 holding polymerizable and/or cross-linkable material 300 enclosed in a frangible vial 400, and an applicator tip 500 (described in greater detail below) containing a polymerization and/or cross-linking initiator. Similar applicator designs are shown, for example, in U.S. Pat. Nos. 6,099,807, 6,055,828, 5,981,621, and 5,928,611.

Applicator devices used for Loctite Product No. 11067-2 and Permatex Product No. ATA-1 contain crushable glass ampoules within flexible applicators. However, the compositions within the crushable ampoules are, in both products, adhesive activators, not the adhesive composition itself. In both of these products, the adhesive is contained in a separate dispenser. The dispenser system used for these products is physically similar to that shown in FIG. 1, except that the applicator tip is rectangular in shape, rather than dome-shaped, and the applicator tip is not made of a quenched foam material and does not contain a polymerization and/or cross-linking initiator for an adhesive material contained in the frangible vial.

EP 0 170 526 discloses an applicator device for storing and dispensing a two-component product, such as a two-component adhesive. The applicator includes an inner sealed frangible ampoule containing a curable material, an outer flexible sleeve containing the ampoule, with a dispensing nozzle at one end and being sealed at the other end, and a fibrous material impregnated with accelerant. The fibrous material is positioned at least partly around the ampoule at the orifice end of the container between the ampoule and a nozzle.

U.S. Pat. No. 6,090,397 to Lee et al. discloses kits of parts comprising a first container comprising a cyanoacrylate composition and a second container comprising a compatible antimicrobial agent and, in particular, a compatible iodine containing antimicrobial agent. Mixture of these compositions provide for in situ formation of an antimicrobial polymeric cyanoacrylate film on mammalian skin. The kit may further comprise an applicator means for applying the composition onto mammalian skin. Suitable applicators include brushes, rollers, aerosols, swabs, foams (such as polyethylene foam) and the like.

U.S. Pat. No. 5,525,647 to Eichmiller discloses dental restorative materials and adhesives, and particularly chemically initiated dental restorative materials. The patent discloses a method for controllably affecting the reaction of a chemically initiated liquid dental adhesive, resin or restorative material comprising mixing the adhesive, resin or restorative material with an instrument, or in a mixing container, where at least a portion of the instrument or container has been impregnated with a reaction affecting compound of predetermined amount to accomplish the intended reaction effect. The reaction affecting compound includes compounds that initiate, accelerate or catalyze a chemical setting reaction of the liquid material. Suitable mixing containers and applicator devices include bristle brushes with hollow or solid lumens, a sponge optionally on the end of a wand, absorptive pledgets, mixing wells, and absorptive application instruments. The applicators or containers can be impregnated with the initiator.

Adhesive applicators, including those described above, generally must include an initiator in order to initiate polymerization of the adhesive upon being applied to a substrate, such as skin areas. Well known initiators that can be included in adhesive applicators include, but are not limited to, detergent compositions; surfactants: e.g., nonionic surfactants such as polysorbate 20 (e.g., Tween 20™), polysorbate 80, (e.g., tetrabutylammonium bromide), anionic surfactants such as sodium tetradecyl sulfate, and amphoteric zwitterionic surfactants such as dodecyldimethyl(3-sulfopropyl)ammonium hydroxide, inner salt; amines, imines and amides, such as imidazole, tryptamine, urea, arginine and providine; phosphines, phosphites and phosphonium salts; such as triphenylphosphine and triethyl phosphite; alcohols such as ethylene glycol, methyl gallate, ascorbic acid, tannins and tanic acid; inorganic bases and salts, such as sodium bisulfite, magnesium hydroxide, calcium sulfate and sodium silicate; sulfur compounds such as thiourea and polysulfides; polymeric cyclic ethers such as monensin, nonactin, crown ethers, clixerenes and polymeric epoxides; cyclic and acyclic carbonates, such as diethyl carbonate; phase transfer catalysts such as Aliquat 336; organometallics such as cobalt naphenate and manganese acetylacetonate; and radical initiators and radicals, such as di-t-butyl peroxide and azobisisobutyronitrile. Although these initiators are effective in initiating polymerization of applied adhesives, such initiators increase the overall cost and complexity of manufacturing adhesive applicators.

### SUMMARY OF THE INVENTION

Despite the numerous applicator designs, there is a need in the art for improved adhesive applicators with simpler designs, which can preferably initiate polymerization of applied adhesives during application without the need for added polymerization initiators.

The present invention addresses this need and provides a quenched foam material that can be used, for example in an adhesive applicator, to both apply and initiate the polymerization of polymerizable adhesive compositions. The present invention also provides methods of applying adhesives using such an applicator and methods of initiating polymerization using the quenched foam material of the present invention.

As used herein, “applicator” or other forms of the word are used to refer to either all or part of an application device used to apply a material to a substrate. Thus, for example, “applicator” can be used to refer to an entire device, such as in the case of a foam pad or a foam pad attached to a suitable support structure, or only to part of the device, such as where the quenched foam material is attached to a handle member as in the form of a swab or is inserted in the end of an mechanical device in the form of a tip. “Applicator tip” as used herein, generally refers to a portion of the applicator that is used to directly apply the polymerizable material to a substrate.

Generally, quenched foam can be produced by immersing foam in a tank filled with a caustic solution that dissolves the cell membranes (i.e., windows) of the foam. Herein the term “caustic” generally refers to caustic soda solutions, such as NaOH, but any similar or equivalent material can also be used. Following immersion of the foam, the foam is washed using a clear water. Once quenched, the foam generally appears duller and more skeletal in appearance. In addition, the quenched foam is softer and is more suitable for filtration purposes, because it is more tortuous.

The inventors of the present invention have discovered that polymerizable or cross-linkable materials, including but not limited to, 1,1-disubstituted monomer materials such as cyanoacrylate adhesive compositions, react differently with different types of foams. More specifically, the inventors herein have discovered that polymerizable and/or cross-linkable compositions demonstrate a high level of compatible reactivity with quenched foam. The inventors have discovered that polymerizable and/or cross-linkable compositions can be applied using a quenched foam, and that the quenched foam can initiate polymerization of the applied composition in the absence of an additional, conventional initiator. As a result, the present invention is directed to methods of, and applicators for, applying and initiating polymerization of polymerizable and/or cross-linkable compositions using a quenched foam material.

By using quenched foam to initiate polymerization of applied polymerizable and/or cross-linkable compositions, the methods and applicators of the present invention can effectively initiate polymerization without the need for additional conventional initiators. Thus, the present invention can substantially eliminate the added cost and inconvenience of having to incorporate additional initiators into adhesive applicators.

Accordingly, in embodiments, the present invention addresses the above and other needs by providing applicators that include a quenched foam material to eliminate the need for additional polymerization initiators. A benefit provided by the present invention is thus the ability to more easily and economically initiate polymerization during application in the absence of additional, conventional initiators.

In all suitable embodiments, the applicator of the present invention is configured so that the adhesive material comes in contact with the quenched foam material immediately prior to application of the adhesive material. Accordingly, polymerization of the adhesive material is initiated by the quenched foam.

### BRIEF DESCRIPTION OF THE DRAWINGS

These and other advantages and features of this invention will be apparent from the following, especially when considered with the accompanying drawings, in which:

FIG. 1 is a side elevational view of an applicator device according to the present invention.

FIG. 2 is a perspective view of an alternative applicator device according to the present invention.

FIG. 3 is a side elevational view of an alternative applicator device according to the present invention.

FIG. 4 is a cross-sectional view of an alternative applicator device according to the present invention.

FIG. 5 is a partial elevational view of a polymerizable material container that forms an exemplary embodiment of an applicator in accordance with the present invention when connected to the applicator tip of FIG. 4.

### DETAILED DESCRIPTION OF PREFERRED EMBODIMENTS

Quenched foams refer to conventional foam materials that have generally been processed after their manufacture to alter the structure of the foam. In particular, as described above, quenched foams can be produced by immersing a conventional foam in a tank filled with a caustic solution that generally dissolves the cell membranes (i.e., windows) of the foam. Following immersion of the foam, the foam is suitably washed with, for example, a clear water. Once quenched, the foam appears duller and more skeletal in appearance. In addition, the quenched foam is softer and is more suitable for filtration purposes, because it is more tortuous.

Quenched foams are thus very different from other reticulated foams. Reticulated foams such as thermally reticulated foams, also known as zapped foams, are also formed by being processed after their manufacture to alter the structure of the foam. In thermal reticulation, the foam is placed in a chamber, a vacuum is pulled, and the chamber is filled with a mixture of gases. The gases are ignited and the flame is passed through the foam. This process removes the cell membranes (windows) giving the strands of the foam a polished surface. Whereas the quenching process can generally only be applied to ester-based foams and some ether-based foams, thermal reticulation can be applied to most ester-based and ether-based foams.

The present invention provides devices and methods for initiating the polymerization of polymerizable or cross-linkable materials, including 1,1-disubstituted ethylene monomer materials such as cyanoacrylate adhesive compositions, using a quenched foam material. The method of the present invention generally includes any process wherein a polymerizable or cross-linkable material is placed in contact with a quenched foam material to initiate polymerization of the polymerizable or cross-linkable material. One suitable device and method, according to the present invention, includes contacting a polymerizable or cross-linkable material with a quenched foam material so that polymerization of the polymerizable or cross-linkable material is initiated upon contact with the quenched foam, followed by application of the polymerizable or cross-linkable material to a substrate. For example, the polymerizable or cross-linkable material may be contacted with the quenched foam by applying the polymerizable or cross-linkable material to the quenched foam, dipping the quenched foam applicator (or portion thereof) into a supply of polymerizable or cross-linkable material, or expressing the polymerizable or cross-linkable material through the quenched foam. Other variations of contacting the materials will be apparent and are encompassed by the present invention.

Moreover, while the methods of the present invention for initiating the polymerization of such materials through contact with a quenched foam material can be accomplished using a variety of techniques, one suitable way of initiating polymerization of polymerizable or cross-linkable materials is to apply such materials using a device comprising a quenched foam applicator that ensures that the polymerizable or cross-linkable material comes in contact with the quenched foam during application of the adhesive material. Thus, in an exemplary embodiment of the present invention, contact between an applied polymerizable or cross-linkable material can be made by including an appropriate quenched foam material in a tip or other application portion of an applicator. Of course, numerous other techniques are possible, and would be readily apparent to those of ordinary skill in the art.

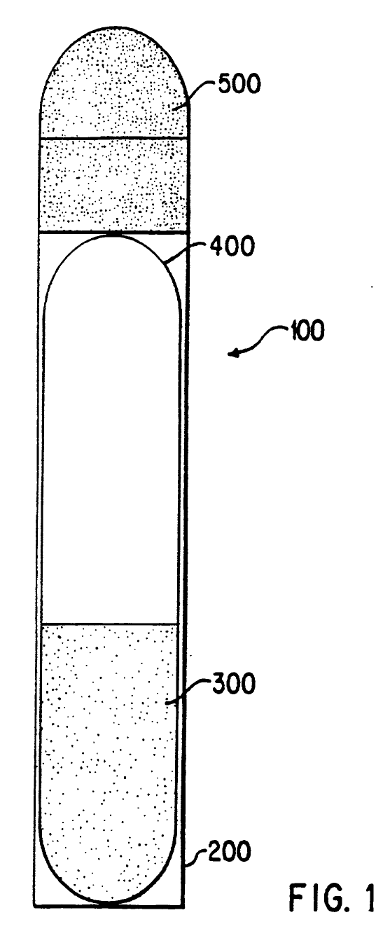

The present invention also provides adhesive applicators with quenched foam portions, suitable for use in applicator devices of the type shown in FIG. 1, which provide significant improvement in the application, polymerization and use of adhesive material. In this and similar embodiments, the quenched foam is used to form the tip or application portion of the overall applicator device. The quenched foam materials of the present invention can thus be used, for example, in combination with the adhesive compositions and packaging and dispensing systems set forth in U.S. Pat. No. 5,928,61 1, the entire disclosure of which is incorporated herein by reference. Of course, other adhesive compositions, compatible with the applicators of the present invention, can also be used.

According to the present invention, various quenched foam applicators are provided that can be used to more easily and economically initiate polymerization and more precisely apply adhesive material at a desired application site. Quenched foam applicators of the present invention can be used on any of a wide variety of applicator devices, such as the applicator devices disclosed in the above-referenced U.S. Pat. No. 5,928,611. Other known applicator bodies, such as squeeze tubes, syringes, swabs and the like are also amenable to use in some embodiments of the present invention.

For example, the present invention is in no way limited to applicators of the structure shown in FIG. 1. Rather, the quenched foam materials and applicators of the present invention can be used in any suitable adhesive applicator device. For example, a second embodiment of an applicator according to the present invention is shown in FIG. 2. The applicator 10 comprises a handle portion 26 and an applicator body 12 having an internal cavity 14. The applicator body 12 is provided with a substantially planar base plate 16 which is open to the internal cavity 14, which is shown as housing the polymerizable 1,1-disubstituted ethylene monomer 18, in an ampoule 24. While the exemplary embodiment shown in FIG. 2 includes the base plate 16, it should be understood that the base plate 16 is optional. Likewise, while the exemplary embodiment includes an internal cavity 14 housing the polymerizable 1,1 -disubstituted ethylene monomer 18 in an ampoule 24, modifications of the applicator can be made where these components are altered or omitted, as desired. A porous material member 20, having an application surface 22, and made of or including the quenched foam according to the present invention is connected to the applicator body 12 opposite the internal cavity 14. As shown in FIG. 2, when the base plate 16 is included, the porous material member 20 may be connected to the base plate 16 and may be sized accordingly. Further, the porous material member 20 may be in the form of a sponge as illustrated in FIG. 2, or may be in any other suitable form such as a fabric or a membrane. The porous material member 20 is preferably disposed substantially parallel to a longitudinal axis A of the internal cavity 14. In the exemplary embodiment shown, the porous material member 20 is also adjacent to the internal cavity 14.

Such embodiments preferably prevent the monomer formulation 18 from flowing into the porous material member 20 from the internal cavity 14 before application of the monomer formulation 18 is desired. As shown in FIG. 2, such flow may be prevented by the ampoule 24 in which the monomer formulation 18 is contained. The ampoule 24 should be frangible so that the polymerizable 1,1-disubstituted ethylene monomer will be allowed to flow into the porous material member 20 from the internal cavity 14 when application of the monomer 18 is desired. The ampoule 24 should be made of a material providing storage stability for the particular 1,1-disubstituted ethylene monomer formulation 18. For certain formulations, glass is a suitable material. Also, as disclosed in U.S. patent application Ser. No. 09/430,289 filed Oct. 29, 1999, which is incorporated herein by reference in its entirety, polymeric and modified polymeric materials may be used. Alternatively or in addition, a stabilizer, such as those disclosed in the incorporated references, may be added to the 1,1-disubstituted ethylene formulation 18 or to the ampoule material.

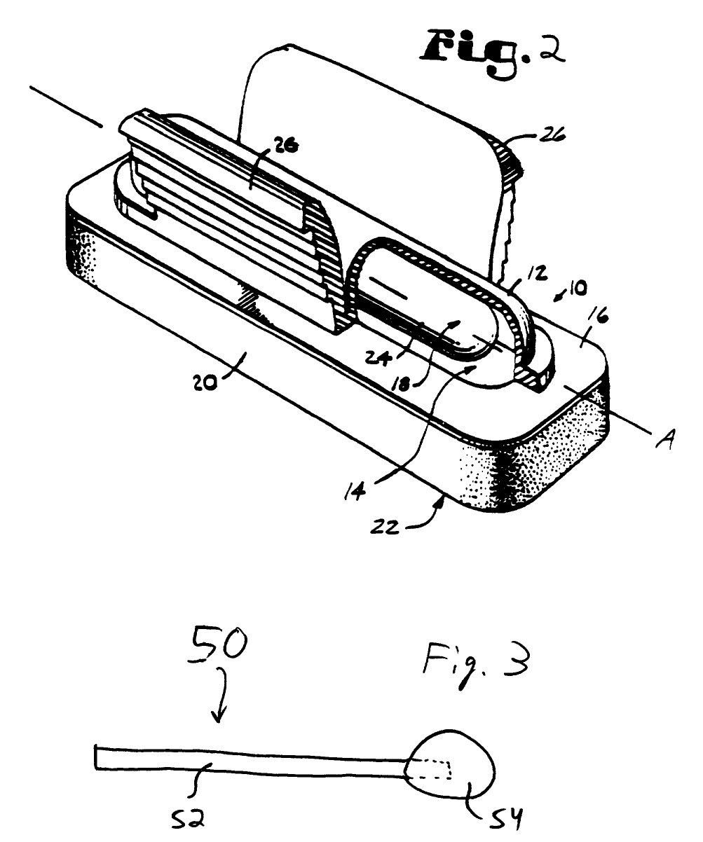

A further embodiment of an applicator according to the present invention is shown in FIG. 3. As shown in FIG. 3, the applicator 50 includes a handle portion 52 and a tip portion 54 attached to the handle portion 52 by any suitable means. The tip portion 54 is made of, or at least includes as a portion thereof, a quenched foam material according to the present invention. The handle portion 52 can be solid or hollow, and when hollow can optionally include a supply of polymerizable adhesive material to be applied using the applicator. When the handle portion 52 is not hollow, or does not contain a supply of polymerizable adhesive material to be applied using the applicator, the applicator tip portion 54 can be contacted with a supply of polymerizable adhesive material, such as by dipping the tip portion 54 into a suitable container of polymerizable adhesive material (not shown) or the like.

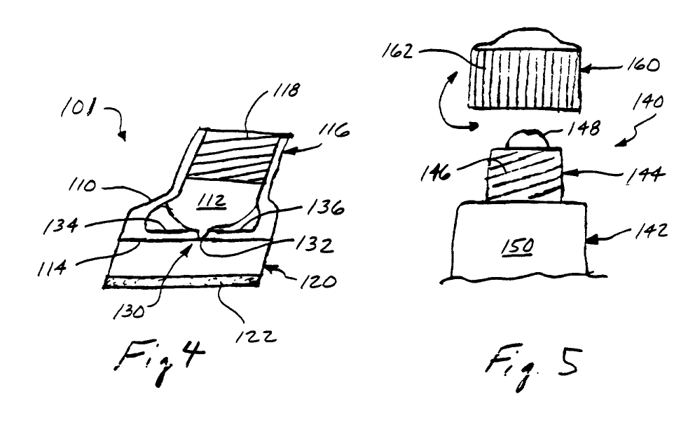

A further exemplary embodiment of an applicator 101 is shown in cross section in FIG. 4. The polymerizable material applicator 101 comprises an applicator body 110 having an internal cavity 112. The applicator body 110 is provided with a substantially planar base 114 that closes an end of the internal cavity 112. While the exemplary embodiment shown in FIG. 4 includes the base 114, it should be understood that the base 114 is optional. In embodiments, a porous material member 120 is connected to the applicator body 110 so that the porous material member 120 may be in fluid communication with the internal cavity 112. As shown in FIG. 4, when the base 114 is included, the porous material member 120 may be connected to the base 114 and may be sized accordingly. Further, the porous material member 120 may be a sponge as illustrated in FIG. 4, or may be any other suitable material such as a fabric, for example, a nylon fabric, or a membrane.

The porous material member 120 may or may not be included. Further, when included, the porous material member 120 may be disposed anywhere as long as it is in fluid communication with the internal cavity 112. For example, the porous material member 120 may be disposed in the internal cavity 112. One or more additives, such as polymerization affecting agents, bioactive agents, colorants or the like, may be included in the porous material member 120. In particular, the entire porous material member 120, or a surface or layer thereof, may be impregnated with the additive(s). For example, an application surface 122 of the porous material member 120 remote from the internal cavity 112 may be coated with the additive(s). Alternatively, if the porous material member 120 is omitted, or in addition, if the porous material member 120 is in the internal cavity 112, the application surface 122 coated with such additives may be part of the applicator tip body 110. In any case, the desired amount of the additive may be determined based on the amount of the polymerizable 1,1-disubstituted ethylene monomer formulation, the particular formulation thereof, or the particular application.

According to the present invention, however, at least a portion of the porous material member 120 is formed using the quenched foam described herein.

In the exemplary embodiment shown, the porous material member 120 is adjacent to the internal cavity 112, but separated from the internal cavity 112 by a valve member 130. The valve member 130 is shown in FIG. 4 as a variable slit 132 formed in the base 114 of the applicator body 110. However, it should be understood that any other known or hereafter developed valve device may be used. For example, a mechanical valve, such as a spring valve, may be used. Embodiments of the valve member 130 are pressure-controlled, as described below. In the exemplary embodiment, the valve member 130 is formed by a first flexible portion 134 and a second flexible portion 136. The flexible portions 134 and 136 are arranged to bend inwardly towards the internal cavity 112, or outwardly towards the porous material member 120, to widen the slit 132 placing the internal cavity 112 in fluid communication with the porous material member 120. The operation of the valve member 130 is described further below.

A female fitting portion 116 of the applicator body 110 defines an end that opens into the internal cavity 112. As shown, the female fitting portion 116 may be opposite the valve member 130 and the porous material member 120. The female fitting portion 116 shown in the embodiment of FIG. 4 includes female screw threads 118. In other words, screw threads 118 are formed on an inner surface of the female fitting portion 116. As described below, the female fitting portion 116 and screw threads 118 are designed to mate with a container to form an applicator according to this invention.

An exemplary embodiment of a polymerizable 1,1-disubstituted ethylene monomer formulation container 140 is shown in FIG. 5. A body 142 of the container 140 is shown cutaway since the container body 142 may be of any desired shape or configuration. For example, the container body 142 may include features that improve gripping or facilitate controlled squeezing. The container body 142 houses an amount of a polymerizable material 150, preferably in a composition as discussed below. Thus, only the internal size of the container body 142 is constrained by the desired amount of the polymerizable 1,1-disubstituted ethylene monomer formulation 150.

In the exemplary embodiment, the container body 142 is provided with a male fitting portion 144. Further, the container body 142 may include a dispensing tip 148 that may include an opening (not shown) or may be readily piercable to allow the monomer 150 to flow from the container 140. The male fitting portion 144 includes male screw threads 146 corresponding to the female screw threads 118 of the female fitting portion 116 of the applicator tip 101 shown in FIG. 4. A female cap member 160 may be used to close the container 140 prior to use, between uses, and/or after use. In particular, prior to use, the female cap member 160 may hermetically seal the container 140. The female cap member 160 includes internal threads (not shown) that mate with the male screw threads 146. Further, the female cap member 160 may include vertical ribs or grooves 162 that facilitate manual rotation of the cap member 160 relative to the container 140. Of course, other attachment methods can also be used including, but not limited to, snap-fit attachment, friction-fit attachment, and the like.

The exemplary embodiments of the applicator 101 and the container 140 shown in FIGS. 4 and 5, respectively, may be connected to form a polymerizable 1,1-disubstituted ethylene monomer formulation applicator according to the present invention. First, the female cap member 160 is unscrewed and removed from the male fitting portion 144 of the container 140. If necessary, the dispensing tip 148 is then pierced. Then, the male fitting portion 144 is aligned with the female fitting portion 116 of the applicator tip 101 so that the male screw threads 146 engage the female screw threads 118. By turning the applicator tip 100 relative to the container 140, vice versa, or both simultaneously, the male fitting portion 144 is releaseably secured within the female fitting portion 116.

During assembly, or at least once assembled, the formulation 150 may flow due to gravity into the internal cavity 112 of the applicator 101. Then, the container 140 may be squeezed to apply pressure that causes the formulation 150 to flow and press against the first and second flexible portions 134, 136. Once the first and second flexible portions 134, 136 are forced outward to widen the variable slit 132 of the valve member 130, the formulation 150 flows into the porous material member 120. Once the pressure is released, the variable slit 132 of the valve member 130 closes to prevent undesired flow of the formulation 150 into the porous material member 120.

Additional disclosure of an applicator such as that shown in FIGS. 4 and 5, as well as variations thereof, is contained in U.S. patent application Ser. No. 09/671,340, filed Sep. 27, 2000, the entire disclosure of which is incorporated herein by reference.

Other suitable applicator devices and configurations that can be modified to include the quenched foam materials of the present invention are described in, for example, U.S. patent application Ser. Nos. 09/145,200 filed Sep. 1, 1998, 09/219,851 filed Dec. 23, 1998, 09/385,030 filed Aug. 30, 1999, 09/430,290 filed Oct. 29, 1999, and 09/658,519 filed Sep. 8, 2000, the entire disclosures of which are incorporated herein by reference.

The applicator can, but need not in all embodiments, include a shaped body of porous material. All or part of the shaped body of porous material can be formed using the quenched foam. The shaped body of porous material can be, or can be replaced by, a filter element. The filter element can filter out any glass shards or other solids that may be present in the adhesive composition. The filter or porous shaped body can also, but need not necessarily, contain additional polymerization and/or cross-linking initiators and/or rate modifiers, e.g., accelerators or inhibitors, for the adhesive material, if desired. Suitable porous shaped bodies are disclosed, for example, in U.S. Pat. No. 5,928,611 and in co-pending application Ser. nos. 09/479,059 and t09/479,060, the entire disclosures of which are incorporated herein by reference.

According to the present invention, any suitable foam may be quenched to provide the quenched foam applicator tip. Suitable foams include, for example, but are not limited to, ester-based foams such as polyurethanes, polyester polyurethanes, and polyesters; polyether polyurethanes; polyimides; mixtures thereof, and the like. Such foams can be quenched by any suitable method available in the art including, but not limited to, the above-described process of immersing the desired foam in a tank filled with a caustic solution that dissolves the cell membranes (i.e., windows) of the foam. Any suitable caustic solution can be used including, but not limited to, caustic soda solutions such as NaOH. Following immersion of the foam, the foam is preferably washed using a clear water.

In general, the quenched foam used in the applicators of the present invention can be made according to any of the shapes, constructions, and modifications shown in the above-referenced U.S. Pat. No. 5,928,611 and application Ser. Nos. 09/479,059 and 09/479,060, but modified to include the use of a quenched foam as part or all of the applicator tip described therein.

The quenched foam material for use in the applicators of the present invention may have a variety of suitable shapes, including but not limited to conical, dome-shaped, cylindrical, chisel, flat (planar), or polygonal shapes. Likewise, any of these configurations can include a number of modifications, including grooves on or in the applicator tip to help channel the adhesive, or one or more cuts in or through the material. These and other modifications as disclosed in U.S. patent application Ser. Nos. 09/479,059 and 09/672,035, the entire disclosure of which are incorporated herein by reference. Any of these configurations can be either solid or hollow, for example, where an interior portion of the quenched foam material is hollowed-out to provide reduced flow path distances of the adhesive material through the material or to allow the material to be placed over a handle or other structural support. For example, the applicator may be a tube, cannula, catheter, single or multi-lumen shape, or comprise a rolling ball, brush, cotton swab or similarly designed structure. Preferably, the applicator is conical. The end having decreased circumference is preferably the end from which the polymerizable material exits from the applicator tip and is fashioned in a manner to facilitate application of the material to any suitable substrate. The length of the quenched foam may also be varied depending on various application parameters, such as the proximity of the applicator container holding the polymerizable and/or cross-linkable material to the substrate to which the material is applied. The size of the portion of the quenched foam from which the polymerizable material exits the applicator may be varied depending on various application parameters, such as the proximity of the applicator container holding the polymerizable and/or cross-linkable material to the substrate to which the material is to be applied, as well as depending on the application.

The applicator container according to the present invention, as applicable, may also be in a variety of shapes and sizes depending on the intended use. For example, for application of limited amounts of polymerizable and/or cross-linkable material, the applicator container may be a syringe, a tube, a vial, a bulb or a pipette. For example, a frangible closed tube of polymerizable and/or cross-linkable material in a flexible container is a preferred type of applicator. For applications of the polymerizable and/or cross-linkable material in greater amounts, applicator containers such as, for example, tanks or reactor vessels may be used.

The quenched foam material forming an applicator tip of the present invention may be detachable from the applicator container holding the polymerizable and/or cross-linkable material. Such an applicator tip could be attached to the applicator container prior to use and detached from the applicator container subsequent to use in order to prevent premature polymerization or cross-linking of the unapplied material in the applicator container. At this point the applicator tip may be discarded and a new applicator tip may be attached to the applicator container for subsequent use or the applicator tip may be reused. A further benefit of detachability of the applicator tip from the applicator body is that this arrangement permits the selection of multiple size and shape tips for a particular application. Thus, for example, a saleable kit can be provided that includes one or more applicators and one or more applicator tips, preferably where the one or more applicator tips are of different sizes and/or shapes.

In other embodiments, the applicator comprising or consisting of the quenched foam material may be a separate unit from the polymerizable material to be applied. Thus, for example, the applicator can be in the form of a swab, having the quenched foam material applied to all or part of an applicator handle. The swab could then be dipped in an amount of polymerizable material, or the polymerizable material could otherwise be applied to the swab. Variations on this structure can also be used, such as in the form of a bristle or solid brush, a roller, and the like.

Additionally, the applicator according to the present invention may comprise multiple parts, with at least one part comprising a quenched foam material. For example, the component comprising the quenched foam may be fabricated separately from the other component(s) of the applicator and assembled prior to attachment to the applicator container.

The quenched foam applicator may also be in the form of a nozzle for atomizing liquid polymerizable and/or cross-linkable materials. Conical, flat spray, condensed stream, and the like nozzles are suitable.

The quenched foam applicator of the present invention may be used in manual or automated applications. For example, manual methods of application can include, but are not limited to, use of hand-held devices such as syringes, adhesive guns, pipettes, eyedroppers, and the like. Automated application processes include, but are not limited to, injection molding and robotic painting/sealing/adhering.

The quenched foam material in the form of an applicator tip and the applicator container may also be an integral unit. The unit may be preformed as a single piece and charged with polymerizable and/or cross-linkable material. After application of material from the applicator container, the unit may be discarded. Additionally, such an integral applicator tip/applicator container may be fashioned to provide the capability of recharging the unit with new material as a multiple use device.

The applicator may be comprised of a variety of materials, but in all embodiments comprises a quenched foam material as at least part of the applicator. The applicator material may be porous, absorbent or adsorbent in nature to enhance and facilitate loading of any additional initiator or other material on or within the applicator. For example, the applicator may be composed of a material having random pores, a honey-comb material, a material having a woven pattern, etc. The degree of porosity will depend on the materials being used.

The quenched foam material of the present invention, where it connects to the applicator container, may have an elongated tubular portion, out of which the mixed polymerizable and/or cross-linking material is expelled. A portion of the applicator that is immediately downstream of the applicator container may be advantageously porous in order to avoid sharp pressure drop and ensure a constant mixed ratio profile. The structure can preferably trap any barriers or materials used to separate multiple containers within the applicator container. Thus, any such barriers will not clog the device.

As stated above, the quenched foam material can form all of part of the applicator. Where the quenched foam forms only a part of the applicator, the quenched foam material can be present, for example, as a surface portion or as an entire surface of the applicator tip, including the interior and/or the exterior thereof Preferably, at least an entire tip portion of the applicator is composed of a quenched foam material. In addition, when an optional additional initiator is used, all or only a portion of the applicator can be coated or treated with the additional initiator.

Alternatively, the initiation rate of the quenched foam can be suitably controlled by altering parameters of the foam material itself, such as the thickness or pore size of the foam. For example, the initiation rate is generally related to the pore size of the foam. As the pore size decreases, the available surface area within the foam increases, thus providing a faster initiation rate. Likewise, the initiation rate is generally related to the thickness of the foam. As the thickness increases, the available surface area within the foam also increases, thus providing a faster initiation rate.

According to the present invention, the applicator can include any suitable adhesive material. The adhesive material can include monomeric (including pre-polymeric) materials, polymeric materials, or mixtures thereof. The monomer (including prepolymeric) adhesive composition may include one or more polymerizable monomers. Preferred adhesive compositions for use in applicators of the present invention are useful as tissue adhesives, sealants for preventing bleeding or for covering open wounds, and in other biomedical applications. They find uses in, for example, apposing surgically incised or traumatically lacerated tissues; retarding blood flow from wounds; dressing burns; dressing skin or other superficial or surface wounds such as compromised skin or other tissue (such as abrasions, chaffed or raw skin, minor cuts and scrapes, sores and/or ulcers such as stomatitis); protecting intact skin; and aiding repair and regrowth of living tissue. Adhesive compositions of the present invention are also useful in industrial and home applications, for example in bonding rubbers, plastics, wood, composites, fabrics, and other natural and synthetic materials.

Preferred monomers that may be used in this invention are readily polymerizable, e.g. anionically polymerizable or free radical polymerizable, or polymerizable by zwitterions or ion pairs to form polymers. Such monomers include those that form polymers, that may, but do not need to, biodegrade. Such monomers are disclosed in, for example, U.S. Pat. No. 5,328,687 to Leung, et al., which is hereby incorporated in its entirety by reference herein.

Particularly preferred adhesive materials are 1,1-disubstituted ethylene monomers including, but not limited to, monomers of the formula:

HRC═CXY (I)

wherein X and Y are each strong electron withdrawing groups, and R is H, —CH═CH₂ or, provided that X and Y are both cyano groups, a C₁-C₄ alkyl group. Examples of monomers within the scope of formula (I) include α-cyanoacrylates, such as ethyl, butyl and/or 2-octyl cyanoacrylate, alkylester cyanoacrylates, such as butyl lactoyl cyanoacrylate or butyl glycol cyanoacrylate, vinylidene cyanides, C₁-C₄ alkyl homologues of vinylidene cyanides, dialkyl methylene malonates, acylacrylonitriles, vinyl sulfinates and vinyl sulfonates of the formula CH₂═CX′Y′ wherein X′ is —SO₂R′ or —SO₃R′ and Y is —CN, —COOR′, —COCH₃, —SO₂R′ or —SO₃R′, and R′ is H or hydrocarbyl.

Furthermore, the adhesive composition contained in the applicator can further include various additives as are known in the art, including but not limited to, the various additives specifically described in U.S. patent application Ser. Nos. 09/479,059 and 09/479,060, the disclosures of which are incorporated herein by reference in their entireties.

Suitable compositions, methods of making such compositions, and methods for incorporating such compositions into a dispenser device are described, for example, in U.S. Pat. Nos. 5,928,611 to Leung; 5,328,687, 5,514,371, 5,514,372, 5,575,997, 5,582,834 and 5,624,669, all to Leung et al; 5,259,835 to Clark et al.; 3,527,841 to Wicker et al.; 3,722,599 to Robertson et al.; 3,995,641 to Kronenthal et al.; and 3,940,362 to Overhults; and U.S. patent application Ser. Nos. 08/266,647, 08/714,288, 09/099,457, 09/430,177, and 09/430,289, the entire disclosures of which are incorporated herein by reference.

Although the quenched foam of the present invention provides suitable and adequate initiation effect to the polymerizable or cross-linkable material, it may be desirable in embodiments to incorporate a further initiator or cross-linking agent into the applicator, such as in the applicator tip. The further inclusion of an initiator or cross-linking agent provides an additive effect to the initiation rate of the quenched foam. That is, the initiation rate of the polymerizable material is faster than if the same initiator or cross-linking agent is used in a non-quenched foam. Such further material can be an additional polymerization and/or cross-linking initiator and/or rate modifier, such as an accelerator or inhibitor, for a polymerizable monomer adhesive material contained in the applicator. Suitable additional polymerization and/or cross-linking initiators and rate modifiers, and methods for applying them to the applicator tip, are described in, for example, U.S. Pat. No. 5,928,611 and U.S. patent application Ser. Nos. 09/430,177, filed Oct. 29, 1999, 09/430,176, 09/430,289, 09/430,290, and 09/430,180 filed Oct. 29, 1999; 09/343,914 filed Jun. 30, 1999; 09/385,030 filed Aug. 30, 1999; and 09/176,889 filed Oct. 22, 1998, the entire disclosures of which are incorporated herein by reference. Preferred initiators for some medical uses include benzalkonium chloride, and for some industrial uses include dimethyl toluidine. Such additional initiator or cross-linking agent can be used, for example, to fine-tune the initiation or cross-linking properties of the composition. When used, the additional initiator may be in the form of a solid, such as, but not limited to, a powder or a solid film, or in the form of a liquid, such as a viscous or paste-like material. The initiator can also include numerous additives, such as surfactants or emulsifiers. Preferably the additional initiator is soluble in the polymerizable and/or cross-linkable material, and/or comprises or is accompanied by at least one surfactant, which, in embodiments, helps the initiator co-elute with the polymerizable and/or cross-linkable material. In embodiments, the surfactant may help solubilize the additional initiator in the polymerizable and/or cross-linkable material.

The additional polymerization and/or cross-linking initiator and/or rate modifier can be applied to the quenched foam or other porous shaped body in the applicator by any suitable means, including, but not limited to, spraying, dipping, injecting, or brushing the porous shaped body with a liquid medium containing the polymerization and/or cross-linking material. It is preferably applied by dipping or injecting. For example, it may be applied by pumping of the liquid medium, for example, through a syringe, onto the distal end of the quenched foam or porous shaped body.

The additional polymerization and/or cross-inking initiator and/or rate modifier may be applied by using various application processes. Suitable application processes include, but are not limited to, the specific processes described in U.S. patent application Ser. Nos. 09/479,059 and 09/479,060, the disclosures of which are incorporated herein by reference in their entireties.

Parts of the applicator, if any, that are not formed from quenched foam may be composed of any of a variety of materials including polymerized materials such as plastics, foams, rubber, thermoset resins, films, fibers, or membranes. In embodiments, the applicator may be made from various resins, including but not limited to, various resins described in U.S. patent application Ser. Nos. 09/479,059 and 09/479,060, the disclosures of which are incorporated herein by reference in their entireties. Additionally, the applicator may be composed of materials such as metal, glass, paper, ceramics, and the like.

In embodiments, the quenched foam may have an average pore size suitable for delivery of the adhesive material through or with the applicator. Suitable average pore sizes, according to the present invention, include, but are not limited to, pore sizes described in U.S. patent application Ser. Nos. 09/479,059 and 09/479,060, the disclosures of which are incorporated herein by reference in their entireties.

In embodiments of the present invention, the adhesive composition can have various viscosities. Suitable adhesive composition viscosities include, but are not limited to, viscosities described in U.S. patent application Ser. Nos. 09/479,059 and 09/479,060, the disclosures of which are incorporated herein by reference in their entireties.

Once the applicator assembly is prepared, the assembly (or individual components thereof) can be sterilized according to known practices. Compatibility of the adhesive composition, the applicator, and the packaging, with one or more sterilization procedures is preferred in embodiments of the present invention because many uses of the adhesive compositions, such as many surgical and other medical applications, require sterilized products. In preferred embodiments, there is substantially no initiation of polymerization of monomeric liquid adhesive compositions that affects the utility of the monomer or monomers caused by the sterilization process, even when repeated sterilization steps are applied.

Sterilization of the monomer composition and/or its packaging can be accomplished by techniques known to the skilled artisan, and is preferably accomplished by methods including, but not limited to, the sterilization methods described in U.S. patent application Ser. Nos. 09/479,059 and 09/479,060 and U.S. Pat. No. 6,143,805, the disclosures of which are incorporated herein by reference in their entireties. Thus, examples of suitable sterilization methods include, but not limited to, chemical, physical, and/or irradiation methods. Examples of chemical methods include, but are not limited to, exposure to ethylene oxide or hydrogen peroxide vapor. Examples of physical methods include, but are not limited to, sterilization by heat (dry or moist) or retort canning. Examples of irradiation methods include, but are not limited to, gamma irradiation, electron beam irradiation, and microwave irradiation. A preferred method is electron beam iradiation, as described in U.S. patent application Ser. No. 09/025,472, filed on Feb. 18, 1998, the entire disclosure of which is incorporated herein by reference. The composition and/or applicator tip should also show low levels of toxicity to living tissue during its useful life. In preferred embodiments of the present invention, the applicator tip is sterilized to provide a Sterility Assurance Level (SAL) of at least 10⁻³. In embodiments, the Sterility Assurance Level may be at least 10⁻⁵, or may be at least 10⁻⁵, or may be at least 10⁻⁵.

### EXAMPLES

### Example 1

Various applicators for 2-octyl cyanoacrylate monomer compositions are prepared with varying amounts of initiator loaded on various foam applicator tips. The applicators are prepared in the form of a swab, having a foam material attached to the end of a handle portion, such as shown in FIG. 3. The adhesive compositions all include a stabilized 2-octyl cyanoacrylate adhesive composition. In each Example, 4 drops of the 2-octyl cyanoacrylate monomer composition are applied from a dropper bottle onto the tip portion of a swab applicator.

Six foam materials are evaluated as applicator tips: White Custom; Blue Custom; AQUAZONE™; White Zapped; Green Zapped; and Pink Quenched, all available from FOAMEX. The White Custom, Blue Custom and AQUAZONE™ foams are conventional, non-reticulated foams. The White Zapped and Green Zapped foams are thermally reticulated foams. The Pink Quenched is a quenched foam according to the present invention. Each of the foam materials are 3/16 inch thick, except for the Green Zapped, which has a thickness of ⅛ inch.

The initiator used in each of the applicator tips is benzalkonium chloride in acetone, at a variety of concentrations including: 3, 1, 0.8, 0.6, 0.4, 0. 1, and 0.0 weight % based on the weight of the monomer composition in the applicator.

The compositions are analyzed to determine the cure time of the composition following contact with the foam materials. During the test, if a setting time reaches 1,000 seconds, the setting time indicates that the formulation did not set. Testing for each of the compositions is repeated ten times, and the results are shown as averages in Table 1 below.

Table 1
Setting Time (sec.) of Composition Based
on Applicator Tip and Initiator Concentration

| 1 | Initiator Concentration (wt %) | | | | | | |
|---|---|---|---|---|---|---|---|
| Foam Type | 0.0 | 0.1 | 0.4 | 0.6 | 0.8 | 1.0 | 3.0 |
| Blue Custom | 1000 | 255 | 103 | 88 | 67 | 65 | 36 |
| Pink Quenched | 192 | 57 | 36 | 35 | 36 | 32 | 24 |
| AQUAZONE ™ | 1000 | 199 | 73 | 53 | 52 | 49 | 31 |
| White Zapped | 1000 | 199 | 102 | 93 | 80 | 62 | 33 |
| White Custom | 1000 | 104 | 57 | 50 | 37 | 37 | 32 |
| Green Zapped | 1000 | 633 | 284 | 212 | 183 | 158 | 67 |

As indicated in Table 1, the initial setting time with no initiator for Blue Custom, AQUAZONE™, White Zapped, White Custom and Green Zapped all equal 1,000 seconds. In contrast, the initial setting time for Pink Quenched foam, according to the present invention, is about 200 seconds. The initial setting time of 192 seconds for the Pink Quenched foam indicates that the Pink Quenched foam initiated polymerization of the material without additional initiator being present. This indicates that quenched foams can be used as an initiator for polymerizable monomeric compositions such as cyanoacrylate adhesives.

The results in Table 1 also show that the addition of an initiator to the foam material shortens the setting time of the polymerizable material. This effect is seen both in the quenched foam material, as well as in the non-quenched foam material. However, in the case of the quenched foam material, the added initiator provides an additive effect on the setting time—that is, the setting time is shortened both by the use of the quenched foam and the use of the initiator.

### Example 2

A study is conducted using a stabilized 2-octyl cyanoacrylate adhesive composition to compare the reactivity of selected quenched foams with cyanoacrylate adhesive products. The foams used include: ⅛″ Pink Quenched (Group 1); ⅛″ White Quenched (Group 2); 3/16″ Pink Quenched (Group 3); 3/16″ White Quenched (Group 4); 3/16″ Green Zapped (uninitiated) (Group 5); and 3/16″ Green Zapped (initiated) (Group 6). The foam materials are attached to a handle to form a swab, as in Example 1. Fifteen individuals are chosen to have the study performed on their forearms.

Four drops of the stabilized 2-octyl cyanoacrylate adhesive composition are applied to a swab and a timer is started. When the timer indicates that 10 seconds have passed, the adhesive composition is applied to the inner forearm in a 8 cm long strip. When the timer indicates that 60 seconds have passed, a piece of paper is placed over one end of the applied formulation. Additional pieces of paper are placed over the formulation every 10 seconds at about 1 cm intervals. The placement of additional pieces of paper over the formulation continues until 8 pieces of paper are placed over the formulation or the pieces of paper placed over the formulation no longer become wet when placed over the formulation. A visual examination is made to determine which piece of paper is the first dry piece of paper and the time at which this examination occurs is recorded.

The average standard deviation and median setting time are then calculated for each of the formulations. Table 2 below presents the results of this testing.

TABLE 2

| | Median Setting Time | Standard |
|---|---|---|
| Group/Foam Type | (sec.) | Deviation |
| I - ⅛″ Pink Quenched | 114.6 | 17.3 |
| II - ⅛″ White Quenched | 103.3 | 24.4 |
| III - 3/16″ Pink Quenched | 110.6 | 21.9 |
| IV - 3/16″ White Quenched | 104.0 | 22.3 |
| V - 3/16″ Green Zapped | 119.3 | 16.2 |
| (uninitiated) | | |
| VI - 3/16″ Green Zapped | 92.0 | 15.2 |
| (initiated) | | |

Based on the results of the testing, it is determined that there is a general equivalence between the setting times using the quenched foam, without added initiator, and using an initiated foam. This proves that quenched foam can provide similar setting characteristics as would be provided by an initiated, zapped foam, i.e., that a quenched foam without initiator functions comparably to a zapped foam with initiator.

While the invention has been described with reference to preferred embodiments, the invention is not limited to the specific examples given, and other embodiments and modifications can be made by those skilled in the art without departing from the spirit and scope of the invention.

What is claimed is:

1. An applicator for applying an adhesive material, comprising:
a solid support comprising a quenched foam material,
wherein polymerization of the adhesive material is initiated by the quenched foam material.

2. The applicator of claim 1, wherein said quenched foam material is selected from the group consisting of ester-based foams.

3. The applicator of claim 1, wherein said quenched foam material is selected from the group consisting of polyurethanes, polyester polyurethanes, polyether polyurethanes, polyimides, polyesters, and mixtures thereof.

4. The applicator of claim 1, wherein said applicator does not include a separate polymerization or cross-linking initiator or rate modifier for said adhesive material.

5. The applicator of claim 1, further comprising a polymerization or cross-linking initiator or rate modifier for said adhesive material.

6. The applicator of claim 5, wherein said polymerization or cross-linking initiator or rate modifier is disposed in or on said solid support.

7. The applicator of claim 1, wherein said quenched foam material is prepared by contacting a foam material with a caustic solution to dissolve cell membranes of the foam material..

8. The applicator of claim 1, wherein said quenched foam material is at least one of absorbent or adsorbent.

9. The applicator of claim 1, further comprising an applicator body, wherein said solid support is attached to said applicator body.

10. The applicator of claim 9, wherein said solid support is integral with said applicator body.

11. The applicator of claim 9, wherein said solid support is removably attached to said applicator body.

12. The applicator of claim 9, wherein said applicator body is a container body containing an adhesive material,
wherein said adhesive material is located in said container body in a non-contacting relationship with said solid support prior to dispensing said adhesive material, and
wherein said adhesive material contacts said quenched foam material when the adhesive exits the solid support.

13. The applicator of claim 12, wherein said adhesive material is encapsulated in a frangible vial contained within said container body, said container body being flexible.

14. The applicator of claim 12, further comprising a polymerization or cross-linking initiator or rate modifier for said adhesive material disposed in or on the solid support.

15. The applicator of claim 12, further comprising a polymerization or cross-linking initiator or rate modifier for said adhesive material disposed in said container body in a non-contacting relationship with said adhesive material prior to dispensing said adhesive material.

16. The applicator of claim 1, wherein said applicator is a syringe, a flexible cylinder, a tube, a pipette or an eye dropper.

17. The applicator of claim 1, wherein said applicator is a swab.

18. The applicator of claim 1, wherein said applicator comprises more than one part, at least one of said parts comprising said solid support.

19. The applicator of claim 1, wherein the adhesive material is biocompatible.

20. The applicator of claim 1, wherein said adhesive material is a synthetic or semi-synthetic polymerizable or cross-linkable monomer material.

21. The applicator of claim 1, wherein said adhesive material comprises 1,1-disubstituted ethylene monomers.

22. The applicator of claim 1, wherein said adhesive material comprises α-cyanoacrylate monomers.

23. The applicator of claim 1, wherein a shape of said solid support is selected from the group consisting of dome-shaped, conical, cylindrical, chisel, flat and polygonal shapes.

24. The applicator of claim 23, wherein said solid support has a conical shape.

25. The applicator of claim 24, wherein an end of said conical shaped solid support having decreased circumference is located such that it is the end from which the liquid adhesive exits from the solid support.

26. The applicator of claim 23, wherein said solid support has a chisel shape.

27. The applicator of claim 23, wherein said solid support has a polygonal shape.

28. The applicator of claim 23, wherein said solid support is dome-shaped.

29. The applicator of claim 23, wherein said solid support has a cylindrical shape.

30. The applicator of claim 1, wherein said solid support further comprises a material selected from the group consisting of metal, glass, paper, ceramics, plastics, and cardboard.

31. The applicator of claim 1, wherein said quenched foam causes said adhesive material to polymerize or cross-link at a faster rate than an unquenched foam made of a same material as said quenched foam.

32. The applicator of claim 1, wherein at least said applicator is sterilized.

33. The applicator of claim 1, further comprising a bioactive agent.

34. The applicator of claim 1, wherein said bioactive agent is on or in said quenched foam material.

35. A method of applying an adhesive material to a substrate using the applicator of claim 12, comprising forcing said adhesive material from said container body through said solid support onto said substrate.

36. The method according to claim 35, wherein said substrate is tissue.

37. A method of applying an adhesive material to a substrate using the applicator of claim 1, comprising:
contacting said solid support with said adhesive material, and
applying said adhesive material onto said substrate.

38. The method according to claim 37, wherein said substrate is tissue.

39. A method of applying an adhesive material to a substrate, comprising:
providing an adhesive material and an applicator comprising a quenched foam material;
initiating polymerization or cross-linking of said adhesive material by contacting said adhesive material with said quenched foam;
applying said adhesive material to a substrate; and
allowing said applied adhesive material to set.

40. A kit for applying adhesive material, comprising at least one saleable package containing:
at least one applicator comprising a solid support comprising a quenched foam material, and
a supply of adhesive material,
wherein polymerization of the adhesive material is initiated by the quenched foam material.

41. The kit of claim 40, wherein said at least one applicator is a swab.

42. The kit of claim 40, comprising more than one said applicator.

43. The kit of claim 40, wherein said adhesive material is a synthetic or semi-synthetic polymerizable or cross-linkable monomer material.

44. The kit of claim 40, wherein said adhesive material comprises 1,1 -disubstituted ethylene monomers.

45. The kit of claim 40, wherein said adhesive material comprises α-cyanoacrylate monomers.

46. The kit of claim 40, wherein said solid support includes an additional polymerization or cross-linking initiator or rate modifier for said adhesive material disposed thereon or therein.

47. A kit for applying adhesive material, comprising at least one saleable package containing:
at least one applicator comprising:
a container body;
an adhesive material; and
at least two applicator tips that each comprise a quenched foam material,
wherein the applicator tips are attachable to at least one said applicator.

48. The kit according to claim 47, wherein said at least two applicator tips have different configurations.

49. The kit according to claim 47, wherein said adhesive material is located in said container body.

50. The kit according to claim 47, wherein said quenched foam is selected from the group consisting of ester-based foams.

51. The kit according to claim 47, wherein said kit contains more applicator tips than applicators.

52. The kit according to claim 47, wherein at least two of said applicator tips are of different shapes or different sizes.

53. The kit according to claim 47, wherein each applicator and each applicator tip is individually packaged in a separate container.

54. The kit according to claim 47, wherein at least one applicator and at least one applicator tip are packaged together in a single container.

55. The kit according to claim 47, wherein at least one applicator and at least two applicator tips are packaged together in a single container.

56. The kit according to claim 47, wherein said adhesive material is a synthetic or semi-synthetic polymerizable or cross-linkable monomer material.

57. The kit according to claim 47, wherein said adhesive material comprises 1,1-disubstituted ethylene monomers.

58. The kit according to claim 47, wherein said adhesive material comprises α-cyanoacrylate monomers.

59. The kit according to claim 47, wherein at least one of said applicator tips includes an additional polymerization or cross-linking initiator or rate modifier for said adhesive material disposed thereon or therein.

60. A method of initiating polymerization or cross-linking of an adhesive composition, the method comprising the steps of:
contacting an adhesive composition with a quenched foam material.

61. The method of claim 60, wherein said quenched foam material is selected from the group consisting of ester-based foams, polyether polyurethanes, and polyimides.

62. The method of claim 60, wherein said adhesive composition comprises α-cyanoacrylate monomers.
